(19) United States
(12) Patent Application Publication
(10) Pub. No.: US 2018/0103629 A1
(43) Pub. Date: Apr. 19, 2018

(54) EASY LIFE BAIT BUCKET SYSTEMS

(71) Applicants: Sidney Harris, Granite Shoals, TX (US); Linzi Harris, Granite Shoals, TX (US)

(72) Inventors: Sidney Harris, Granite Shoals, TX (US); Linzi Harris, Granite Shoals, TX (US)

(21) Appl. No.: 15/297,970

(22) Filed: Oct. 19, 2016

(51) Int. Cl. A01K 97/05

(52) U.S. Cl. CPC A01K 97/05

(57) ABSTRACT

An easy life bait bucket system for an aerated bait container, making a system for holding live fishing bait. The easy life bait bucket system may have an outer-bucket and an inner bait bucket. The outer-bucket and the inner bait bucket are structured and arranged in structural and functional combination to repeatedly fill with live fishing bait, to carry to a desired fishing environment, and to access the live fishing bait with one hand of a user. The outer-bucket may have an inner volume configured to removably-accommodate the inner bait bucket, and a first handle. The inner bait bucket may include an inner-lid, a plurality of water-flow holes, a metal ring-attacher, and a second-handle. The inner lid may have a slotted gasket to access the interior of the inner bait bucket.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of fishing bait holders and more specifically relates to live bait bucket systems.

### 2. Description of Related Art

Recreational fishing, also called sport fishing, is fishing for pleasure or competition. It can be contrasted with commercial fishing, which is fishing for profit, or subsistence fishing, which is fishing for survival. Recreational fishing can be done from boats, kayaks, and while standing on the shoreline or wading in to the water. The most common form of recreational fishing is done with a rod, reel, line, hooks, and any one of a wide range of baits. Many fishermen use live bait to lure fish to be caught. The live bait is generally kept in some type of bucket with water to keep the bait alive, and the water needs to be occasionally replenished with fresh, oxygenated water to maintain the bait. The bait bucket is generally kept near the fishing area, and may require a wading fisherman to exit the water to return to the bait bucket for fresh live bait. In addition, when fishing and new bait is required, the fisherman may have to put down the fishing pole or find an alternate holding means for the fishing pole when retrieving new live bait. A suitable solution is desired.

Several attempts have been made to solve the above-mentioned problems such as those found in U.S. Patent and U.S. Publication numbers: U.S. Pat. No. 5,529,204 to Sykes; U.S. Pat. No. 6,584,727 to De Shazer et al.; U.S. Pat. No. 4,890,413 to Nelson, et al.; U.S. Pat. No. 4,794,723 to Arnold, et al.; 2008/0190011 to Neal, et al.; and 2008/0250697 to Wasnick. This art is representative of fishing bait holders. However, none of the above inventions and patents, taken either singly or in combination, is seen to describe the invention as claimed.

Preferably, a fishing bait holder should provide an aerated bait container and, yet would operate reliably and be manufactured at a modest expense. Thus, a need exists for a reliable easy life bait bucket system to avoid the above-mentioned problems.

### BRIEF SUMMARY OF THE INVENTION

In view of the foregoing disadvantages inherent in the known fishing bait holder art, the present invention provides a novel easy life bait bucket system. The general purpose of the present invention, which will be described subsequently in greater detail is to provide an aerated bait container, which can be used with one hand.

An easy life bait bucket system is disclosed in a preferred embodiment comprising a system for holding live fishing bait, which may have an outer-bucket and an inner bait bucket. The outer-bucket and the inner bait bucket are structured and arranged in structural and functional combination to repeatedly fill with live fishing bait, carry to a desired fishing environment, and to access the live fishing bait with one hand of a user. The outer-bucket and the inner bait bucket are made of the durable materials configured to provide for repeated cleaning and sanitization operations.

The outer-bucket may have an inner volume configured to removably-accommodate the inner bait bucket. The outer-bucket may further include a first-handle. The first-handle may be at least partially made of braided flexible nylon, and may be configured for convenient transport of the system. The first-handle may have sufficient strength and durability to support and suspend the system when in a full condition. The outer-bucket may have a truncated-cone shape configured to allow a smaller diameter area to concentrate the live fishing bait for ease of grasping with one hand. Further, the outer-bucket may have a flat base that may be configured to provide stability when placed on a horizontal planar surface. The outer-bucket may further have a textured outer surface that may be configured to provide the outer-bucket with a gripable surface when in a wet condition.

The inner bait bucket may include an inner-lid, a plurality of water-flow holes, a metal ring-attacher, and a second-handle. The inner lid may have a flip-top, a hinge, a latch, and a slotted gasket. Further, the inner lid also may have a seal and flotation-foam. The hinge may be fixedly attached to the inner-lid, and may be configured to secure the flip-top from opening in the latched state in conjunction with the latch.

The plurality of water-flow holes are configured to allow oxygenated water to flow through the inner bucket while retaining the live bait in the inner volume. The plurality of water flow holes are further configured to allow oxygenated water to move into and out of the inner bait bucket when the inner bait bucket is placed in water while in a stand-alone condition. The metal ring-attacher may be configured to be an attachment point for removably-coupling the inner bait bucket in a stand-alone condition to at least one boat, fisherman, or alternatively a dock. Further, the second-handle may be at least partially made of flexible durable nylon suitable for UV exposure and use in water-based environments.

The slotted gasket may be at least partially made of a flexible rubber, and may be configured to retain shape and closure properties when repeatedly accessed by the user to retain and access live fishing bait. The slotted gasket may further be configured to be fixedly-attached to the flip-top with fasteners, such as corrosion-resistant rivet-attachers.

The flip-top may have a latched state and an unlatched state. The latch may be configured to secure the flip-top from opening when the flip-top may be in the latched state, and the latch may be further configured to allow access to the inner bait bucket when the flip-top may be in the unlatched state. The seal may be at least partially made of an elastomeric material, and may be configured to provide the flexible seal for the inner-lid. Further, the inner bait bucket may have an arcuate upper edge configured for leak-resistant contact when compressed against the elastomeric material of the seal when in the closed condition. The flotation-foam may have buoyant properties sufficient to float the system when in water.

The bait bucket system may further be configured as a kit, which may include the bait bucket system and a set of user instructions.

A method of using a bait bucket system may comprise the steps of opening the flip-top of an inner bait bucket; filling the inner bait bucket with live fishing bait; latching the flip-top of the inner bait bucket; carrying the bait bucket system to a desired location; removing the inner bait bucket from an outer bait bucket; attaching the inner bait bucket to at least one boat, fisherman, and alternatively a dock via the metal ring-attacher; and grasping the live fishing bait with one hand.

The present invention holds significant improvements and serves as an easy life bait bucket system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, easy life bait bucket systems, constructed and operative according to the teachings of the present disclosure.

FIG. 1 shows a perspective view illustrating an easy life bait bucket system during an ‘in-use’ condition according to an embodiment of the present disclosure.

FIG. 2 is a perspective view illustrating the easy life bait bucket system present disclosure of FIG. 1.

FIG. 3 is an exploded view illustrating the easy life bait bucket system, according to an embodiment of the present disclosure.

FIG. 4 is a perspective view illustrating an alternative configuration for the easy life bait bucket system, according to an embodiment of the present disclosure.

The various embodiments of the present disclosure will hereinafter be described in conjunction with the appended drawings, wherein like designations denote like elements.

### DETAILED DESCRIPTION

As discussed above, embodiments of the present invention relate to an aerated fishing bait holder and more particularly to an easy life bait bucket system as used to improve live bait containers.

Generally speaking, easy life bait bucket systems may comprise a live bait bucket that can be used with one hand, where the hand can be put through a cut rubber hole, grab bait and remove the bait from the bucket. The design allows the person fishing to only have to use one hand to retrieve bait from the bucket but without the bait being able to leave the bucket. The bait bucket will also float on the water surface and upright itself if it gets turned over in the water. It is ideal for fishing from a kayak, boat, wade fishing and any other situation when fishing and one-handed bait retrieval is desired. The easy life bait bucket system may be approximately nine inches tall, eleven inches in diameter at the top, and may be made of plastic, foam, rubber, stainless steel hardware, rope, and aluminum pop rivets. It is suitable for use in wet, salt-water and fresh-water environments, at various ambient temperatures, and is durable to sunlight exposure.

In further detail, the outside bucket stops water from getting out of bait bucket during transport or when the interior bait bucket is not in use in water. The interior bait bucket holds bait and has holes to let water flow freely in and out, thus keeping bait alive with freshly oxygenated water when placed in water. The flip top lid with a latch in middle of sealed top lid of bucket includes a latch and clip to keep the lid securely closed while bucket is in use but opens easily to put bait into bucket, and let any remaining bait or water out of bucket when finished. Foam on inside of top lid provides flotation for the interior bait bucket when in the water and gives the bucket the necessary buoyancy to upright itself in the event that it gets turned over in the water. A rubber gasket with slits allows the user to use one hand to push through the gasket to grab bait and pull hand with bait out of the bucket but otherwise prevents live bait from exiting unintentionally.

Separate rope handles on the exterior and interior buckets are provided to allow ease of transport and ease of use by allowing the user to push the handles out of the way when they are not needed. Use of rope for the handle decreases the chance of the handle breaking or deteriorating as a result of wear and tear or being in the elements (sun, freshwater, saltwater, etc.). A stainless steel ring on the interior bait bucket hole where the rope goes allows the user to tie a rope of their choice to the ring for kayaking/wade fishing/conventional boat fishing so they can attach the bucket to their kayak, their person, or their boat, as needed, at their desired distance, and without it floating away.

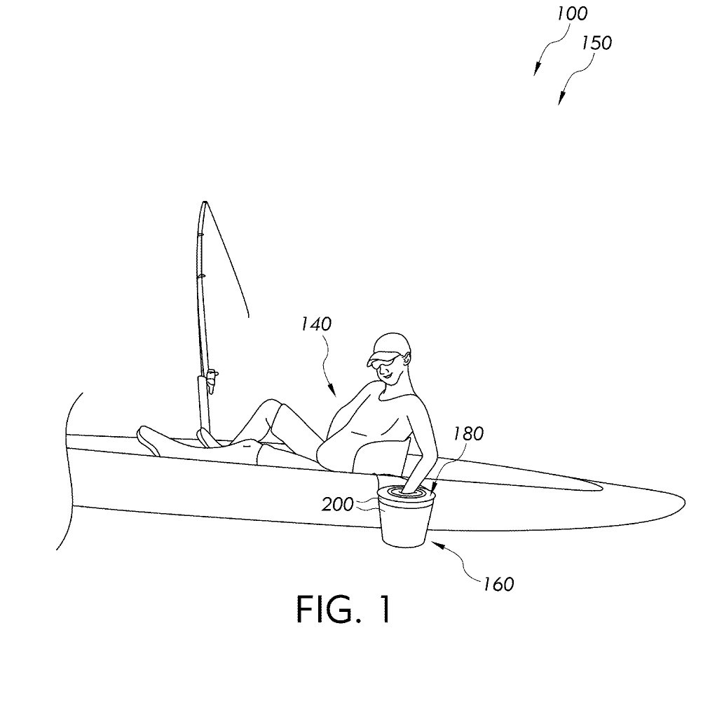

Referring to the drawings by numerals of reference there is shown in FIG. 1, a system for holding live fishing bait (easy life bait bucket system 100), in an ‘in-use’ condition 150 whereby user 140 may hold and access live fishing bait. Easy life bait bucket system 100 may comprise outer-bucket 160 and inner bait bucket 180. Outer-bucket 160 and inner bait bucket 180 are structured and arranged in structural and functional combination to repeatedly fill with live fishing bait, carry to a desired fishing environment, and access live fishing bait with one hand of a user 140. Outer-bucket 160 and inner bait bucket 180 are made of durable materials 200 configured to provide for repeated cleaning and sanitization operations.

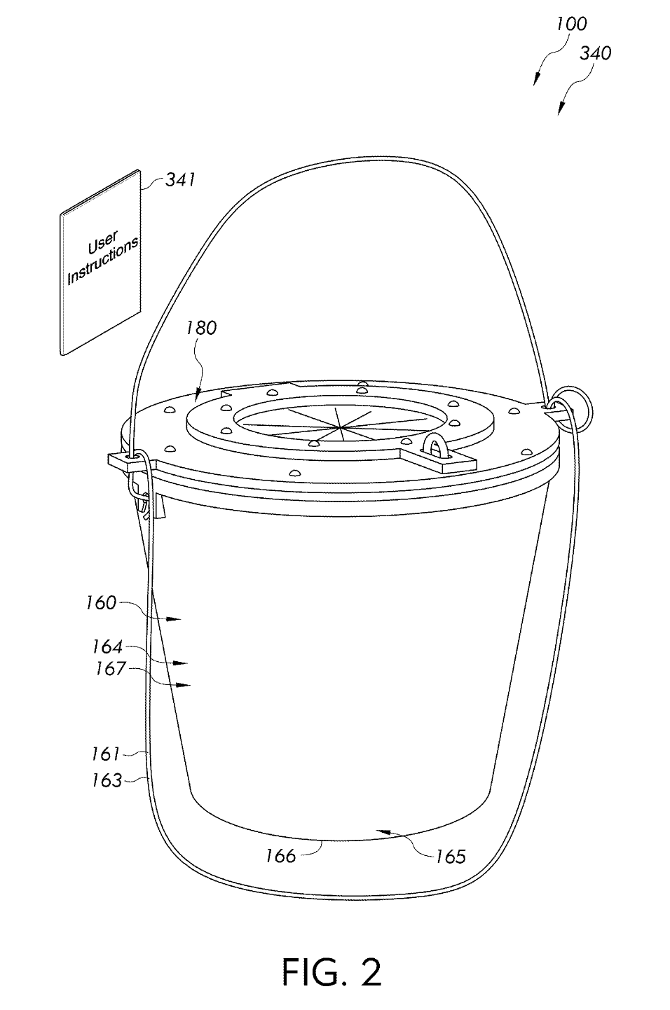

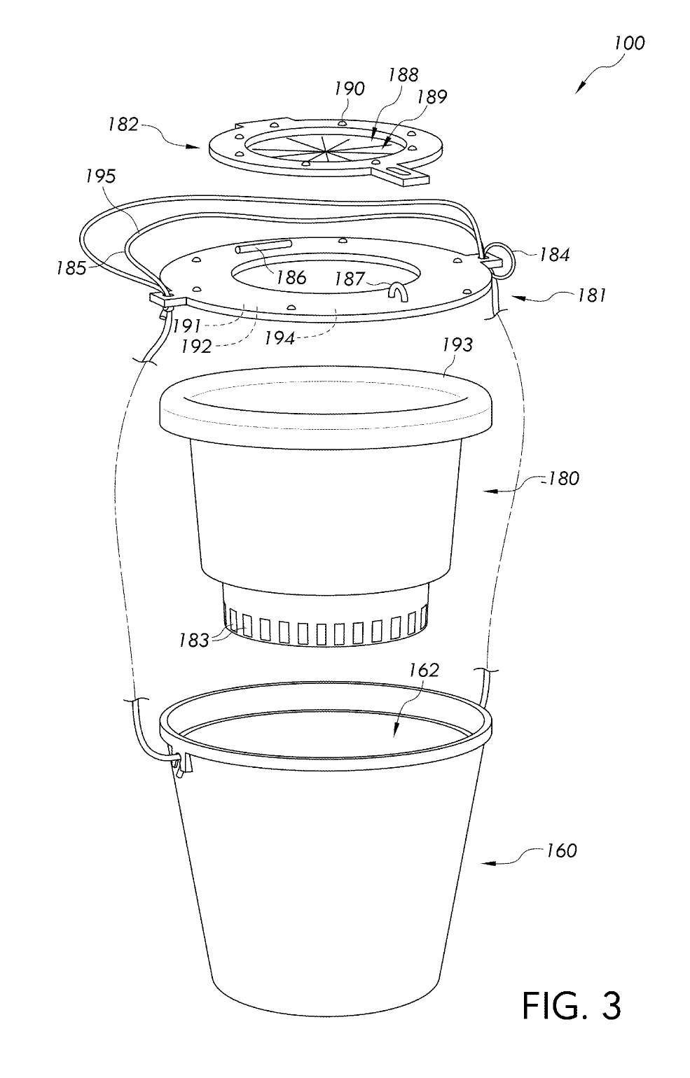

Referring now to FIG. 2, a perspective view illustrating easy life bait bucket system 100, comprising outer-bucket 160 and inner bait bucket 180 according to an embodiment of the present disclosure. Outer-bucket 160 may have inner volume 162 (FIG. 3) configured to removably-accommodate inner bait bucket 180. Further, outer-bucket 160 may include first-handle 161. First-handle 161 may be at least partially made of braided flexible nylon 163, and may be configured for convenient transport of easy life bait bucket system 100. First-handle 161 may have sufficient strength and durability to support and suspend easy life bait bucket system 100 when in a full condition. Outer-bucket 160 (and inner bait bucket 180) may have truncated-cone shape 164 configured to allow smaller diameter area 165 at its bottom to concentrate live fishing bait for ease of grasping with one hand. Outer-bucket 160 may further have a flat base 166 that may be configured to provide stability when easy life bait bucket system 100 is placed on a horizontal planar surface. Outer-bucket 160 may have a textured outer surface 167 that may provide outer-bucket 160 with gripable surface when in a wet condition.

It should be noted that easy life bait bucket system 100 may be adapted as a kit 340 comprising the following parts: at least one easy life bait bucket system 100, and at least one set of user instructions 341. The kit has instructions such that functional relationships are detailed in relation to the structure of the invention (such that the invention can be used, maintained, or the like in a preferred manner). Easy life bait bucket system 100 may be manufactured and provided for sale in a wide variety of sizes and shapes for a wide assortment of applications.

Referring now to FIG. 3, shown is an exploded view illustrating easy life bait bucket system 100, which may include outer-bucket 160 and inner bait bucket 180. Inner bait bucket 180 may include inner-lid 181, plurality of water-flow holes 183, metal ring-attacher 184, and second-handle 185. Inner lid 181 may have flip-top 182, hinge 186, and latch 187. Flip-top 182 may include a pliable interface (e.g., slotted gasket 188) configured to displace under the pressure of a hand and allow the hand to enter the inner bait bucket 180 and to retract to a closed state when the hand is removed, preventing the live bait from exiting freely. Further, inner lid 181 also may have seal 191 and flotation-foam 194. Flip-top 182 may have latched state and unlatched state. Latch 187 may be configured to secure flip-top 182 from opening when flip-top 182 may be in a latched state, and latch 187 may be further configured to allow access to inner bait bucket 180 when flip-top 182 may be in an unlatched state. Slotted gasket 188 may be at least partially made of a pliable or flexible material such as rubber, silicon, or plastic 189 (or the like), and may be configured to retain shape and closure properties when repeatedly accessed by user 140 (FIG. 1) to retain and access live fishing bait. Slotted gasket 188 may further be configured to be fixedly-attached to flip-top 182 with fasteners such as corrosion-resistant rivet-attachers 190 or the like.

In continuing to refer to FIG. 3, hinge 186 may be fixedly attached to inner-lid 181, and may be configured to secure flip-top 182 from opening in a latched state, in conjunction with latch 187. Seal 191 may be at least partially made of elastomeric material 192, and may be configured to provide flexible seal 191 for inner-lid 181. Further, the arcuate upper edge 193 of inner bait bucket 180 may be configured for leak-resistant contact when compressed against elastomeric material 192 of seal 191, when in a closed condition. Flotation-foam 194 may have buoyant properties sufficient to float easy life bait bucket system 100 when in water.

The plurality of water-flow holes 183 are configured to provide oxygenated water flow through inner bucket 180 while retaining live bait in inner volume 162. Plurality of water flow holes 183 are further configured to allow oxygenated water to move into and out of inner bait bucket 180 when inner bait bucket 180 is placed in water while in a stand-alone condition. Metal ring-attacher 184 may be configured to be an attachment point for removably-coupling inner bait bucket 180 in a stand-alone condition to at least one boat, fisherman, or alternatively a dock. Second-handle 185 may be at least partially made of flexible durable nylon 195 suitable for UV exposure and water-based environments.

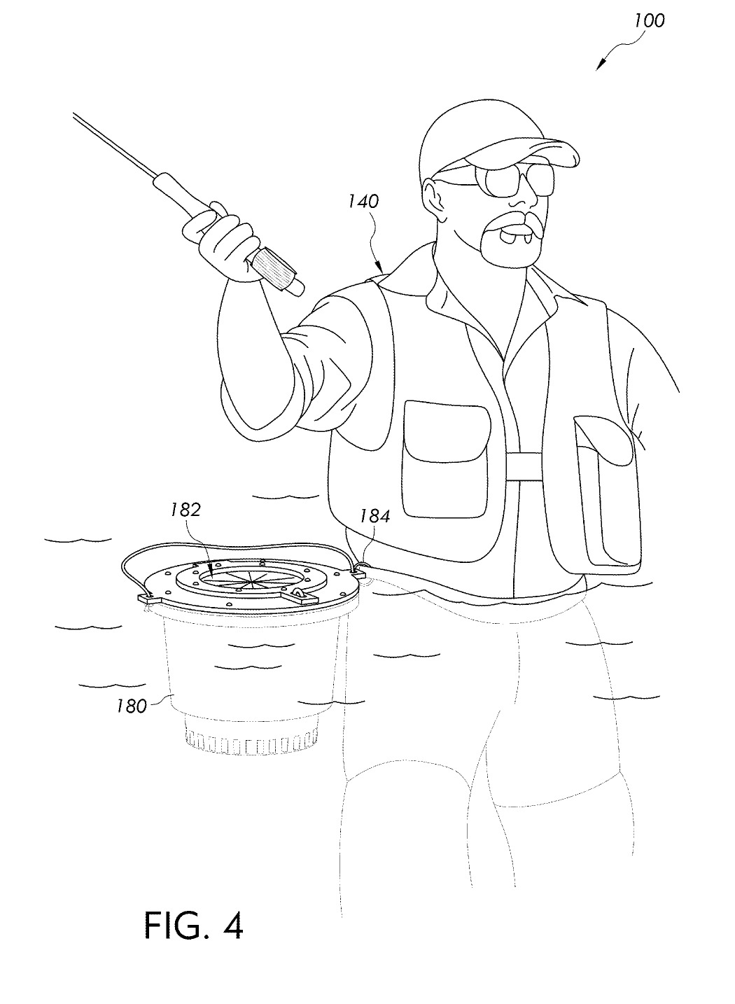

FIG. 4 is a perspective view illustrating an alternative configuration for the easy life bait bucket system 100, according to an embodiment of the present disclosure. Here, the inner bucket 180 is shown floating in the water alongside the user 140. Inner bucket 180 is buoyant in an upright orientation, and is configured to be self-righting. In addition, metal ring-attacher 184 is configured to attach the inner bucket 180 to a belt of the user 140.

A method of use for easy life bait bucket system 100 according to an embodiment of the present disclosure comprises the steps of opening a flip-top 182 of an inner bait bucket 180; filling the inner bait bucket 180 with live fishing bait; latching the flip-top 182 of the inner bait bucket 180; carrying the bait bucket system 100 to a desired location; removing the inner bait bucket 180 from an outer bait bucket 160; attaching the inner bait bucket 180 to at least one of a boat, a fisherman, and a dock via a metal ring-attacher 184; placing inner bait bucket 180 into water where oxygenated water can flow freely through a plurality of water flow holes 183; and grasping the live fishing bait with one hand of a user 140.

Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

It should be noted that the steps described in the method of use can be carried out in many different orders according to user preference. The use of “step of” should not be interpreted as “step for”, in the claims herein and is not intended to invoke the provisions of 35 U.S.C. § 112(f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system for holding live fishing bait, the system comprising:
an outer-bucket including a first-handle; and
an inner bait bucket including
an inner-lid having
a hinge,
a latch,
a flip-top including a slotted gasket,
the inner lid also having a seal and
flotation-foam, the inner bait bucket also including
a plurality of water-flow holes,
a metal ring-attacher, and
a second-handle;
wherein said outer-bucket has an inner volume configured to removably-accommodate said inner bait bucket;
wherein said flip-top has a latched state and an unlatched state;
wherein said latch is configured to secure said flip-top from opening when said flip-top is in said latched state, and said latch is further configured to allow access to said inner bait bucket when said flip-top is in said unlatched state; and
wherein said outer-bucket and said inner bait bucket are structured and arranged in structural and functional combination to repeatedly fill with live fishing bait, to carry to a desired fishing environment, and to access said live fishing bait with one hand of a user.

2. The system of claim 1, wherein said slotted gasket is at least partially made of a pliable material, and is configured to retain shape and closure properties when repeatedly accessed by said user to retain and access said live fishing bait.

3. The system of claim 1, wherein said hinge is fixedly attached to said inner-lid, and is configured to secure said flip-top from opening in said latched state, in conjunction with said latch.

4. The system of claim 1, wherein said seal is at least partially made of an elastomeric material, and is configured to seal against an upper edge of said inner bait bucket.

5. The system of claim 1, wherein said flotation-foam has buoyant properties sufficient to float said system when in water.

6. The system of claim 1, wherein said first-handle is at least partially made of braided flexible nylon, and is configured for convenient transport of the system.

7. The system of claim 1, wherein said first-handle has sufficient strength and durability to support and suspend said system when in a full condition.

8. The system of claim 1, wherein said plurality of water flow holes are configured to allow oxygenated water to move into and out of said inner bait bucket when said inner bait bucket is placed in water in a stand-alone condition.

9. The system of claim 1, wherein said metal ring-attacher is configured to be an attachment point for removably-coupling said inner bait bucket in a stand-alone condition to at least one of a boat, a fisherman, and a dock.

10. The system of claim 1, wherein said second-handle is at least partially made of flexible durable nylon suitable for UV exposure and water-based environments.

11. The system of claim 1, wherein said outer-bucket has a truncated-cone shape having a smaller diameter area at a lower end of the outer-bucket, and is configured to concentrate said live fishing bait when at the lower end of the outer-bucket.

12. The system of claim 4, wherein said inner bait bucket has an upper edge configured for leak-resistant contact when compressed against said elastomeric material of said seal when in a closed condition.

13. The system of claim 1, wherein said outer-bucket has a flat base that is configured to provide stability when placed on a horizontal planar surface.

14. The system of claim 1, wherein said outer-bucket has a textured outer surface that is configured to provide said outer-bucket with a gripable surface when wet.

15. The system of claim 8, wherein said plurality of water-flow holes are configured to allow said oxygenated water to flow through said inner bucket while retaining said live bait in said inner volume.

16. The system of claim 1, wherein said outer-bucket and said inner bait bucket are made of durable materials configured to provide for repeated cleaning and sanitization.

17. The system of claim 1, wherein said slotted gasket is configured to be fixedly-attached to said flip-top with corrosion-resistant rivet-attachers.

18. A system for holding live fishing bait, the system comprising:
an outer-bucket including a first-handle; and
an inner bait bucket including
an inner-lid having
a flip-top including a slotted gasket, a hinge, and a latch,
the inner lid also having a seal, and
flotation-foam, the inner bait bucket also including
a plurality of water-flow holes,
a ring-attacher, and
a second-handle;
wherein said outer-bucket has an inner volume configured to removably-accommodate said inner bait bucket;
wherein said flip-top has a latched state and an unlatched state;
wherein said latch is configured to secure said flip-top from opening when said flip-top is in said latched state, and said latch is further configured to allow access to said inner bait bucket when said flip-top is in said unlatched state;
wherein said slotted gasket is at least partially made of a flexible material, and is configured to retain shape and closure properties when repeatedly accessed by said user to retain and access said live fishing bait;
wherein said hinge is fixedly attached to said inner-lid, and is configured to secure said flip-top from opening in said latched state in conjunction with said latch;
wherein said seal is at least partially made of an elastomeric material, and is configured to seal against an upper edge of said inner-lid;
wherein said flotation-foam has buoyant properties sufficient to float said system when in water;
wherein said first-handle is at least partially made of braided flexible nylon, and is configured for convenient transport of the system;
wherein said first-handle has sufficient strength and durability to support and suspend said system when in a full condition;
wherein said plurality of water flow holes are configured to allow oxygenated water to move into and out of said inner bait bucket when said inner bait bucket is placed in said water in a stand-alone condition;
wherein said ring-attacher is configured to be an attachment point for removably-coupling said inner bait bucket in a stand-alone condition to at least one of said boat, said fisherman, and said dock;
wherein said second-handle is at least partially made of flexible durable nylon suitable for said UV exposure and said water-based environments;
wherein said outer-bucket has a truncated-cone shape having a smaller diameter area at a lower end of the outer-bucket, and is configured to concentrate said live fishing bait when at the lower end of the outer-bucket;
wherein said outer-bucket has an upper edge configured for leak-resistant contact when compressed against said elastomeric material of said seal when in said closed condition;
wherein said outer-bucket has a flat base that is configured to provide stability when placed on said horizontal planar surface;
wherein said outer-bucket has said textured outer surface that is configured to provide said outer-bucket with said gripable surface when in said wet condition;
wherein said plurality of water-flow holes are configured to provide said oxygenated water to flow through said inner bucket while retaining said live bait in said inner volume;
wherein said outer-bucket and said inner bait bucket are made of durable materials configured to provide for repeated cleaning and sanitization operations;
wherein said slotted gasket is configured to be fixedly-attached to said flip-top with corrosion-resistant rivet-attachers; and
wherein said outer-bucket and said inner bait bucket are structured and arranged in structural and functional combination to repeatedly fill with live fishing bait, to carry to a desired fishing environment, and to access said live fishing bait with one hand of said user.

19. The system of claim 18, further comprising a set of user instructions, the system arranged as a kit.

20. A method of using a bait bucket system, the method comprising the steps of:
opening a flip-top of an inner bait bucket;
filling said inner bait bucket with live fishing bait;
latching said flip-top of said inner bait bucket;
carrying said bait bucket system to a desired location;
removing said inner bait bucket from an outer bait bucket;
attaching said inner bait bucket to at least one of a boat, a fisherman, and a dock via a ring-attacher;
placing inner bait bucket into water where oxygenated water can flow freely through a plurality of water flow holes; and
grasping said live fishing bait with one hand.
